(19) United States
(12) Patent Application Publication
(10) Pub. No.: US 2005/0122984 A1
(43) Pub. Date: Jun. 9, 2005

(54) ROAMING COMMUNICATION SYSTEM OVER INTERNET

(76) Inventor: Heng-Chien Chen, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/707,382

(22) Filed: Dec. 9, 2003

(51) Int. Cl. H04L 12/66

(52) U.S. Cl. 370/401; 370/338; 370/352

(57) ABSTRACT

A roaming communication system includes a first local telephone system, a first communication module connected to the first local telephone system and connected to the Internet through a first dynamic IP address, a second local telephone system, and a second communication module connected to the second local telephone system and connected to the Internet through a second dynamic IP address. The first and second communication modules are each capable of converting voice signals respectively received from the first and second local telephone systems to voice packets for transmission over the Internet and are capable of restoring voice packets received through the Internet into voice signals. The roaming communication system also includes a host connected to the Internet through a static IP address. The host is used to control voice packet traffic between the first communication module and the second communication module.

### BACKGROUND OF INVENTION

1. Field of the Invention

The present invention relates to a telephone communication system, and more specifically, to a roaming telephone communication system created across the Internet by using dynamic Internet Protocol (IP) addresses.

2. Description of the Prior Art

With the growing popularity of high-speed Internet connections, it is now feasible for Voice over Internet Protocol (VoIP) phone calls to be made over the Internet. One main advantage of VoIP is that VoIP phone calls are significantly less expensive than phone calls made solely over a public switched telephone network (PSTN).

Please refer to FIG. 1. FIG. 1 is a functional block diagram of a VoIP system 10 according to the prior art. The VoIP system 10 connects a first voice gateway 16 to a second voice gateway 22. Each of the first and second voice gateways 16 and 22 is connected to each other through respective Internet connections 14 and 20. The Internet connections 14 and 20 may be an xDSL connection or another suitable broadband Internet connection. The Internet connection 20 provides a static IP address to each of the first and second voice gateways 16 and 22. The first voice gateway 16 is connected to a normal telephone 18 for allowing the normal telephone 18 to make phone calls through the Internet 12. The second voice gateway 22 is connected to a private branch exchange (PBX) 24, which provides telephone service to a plurality of phone extensions 26.

Each of the first and second voice gateways 16 and 22 converts voice signals into voice packets for transmitting the voice packets via the Internet 12. Likewise, the first and second voice gateways 16 and 22 convert voice packets received through the Internet 12 into voice signals that are then sent to the appropriate normal telephone 18 or phone extension 26. Unfortunately, the VoIP system 10 requires each of the first and second voice gateways 16 and 22 to be connected to the Internet 12 through a static IP address. Not only are static IP addresses more expensive than dynamic IP addresses, but also neither of the first and second voice gateways 16 and 22 can be easily moved since the static IP address service would have to be moved to another location as well.

### SUMMARY OF INVENTION

It is therefore an objective of the claimed invention to provide a roaming communication system that can be connected through dynamic IP addresses in order to solve the above-mentioned problems.

According to the claimed invention, a roaming communication system includes a first local telephone system, a first communication module connected to the first local telephone system and connected to the Internet through a first dynamic IP address, a second local telephone system, and a second communication module connected to the second local telephone system and connected to the Internet through a second dynamic IP address. The first and second communication modules are each capable of converting voice signals respectively received from the first and second local telephone systems to voice packets for transmission over the Internet and are capable of restoring voice packets received through the Internet into voice signals. The roaming communication system also includes a host connected to the Internet through a static IP address. The host is used to control voice packet traffic between the first communication module and the second communication module.

It is an advantage of the claimed invention that the first and second communication modules can easily be connected to the roaming communication system through a connection to the Internet using a dynamic IP address. Thus, new communication modules can easily be added to the roaming communication system at any time, and without additional cost involved to register a static IP address. Moreover, the roaming communication system only requires a single host, and does not require a voice gateway at each geographical location of the roaming communication system.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of a VoIP system according to the prior art.

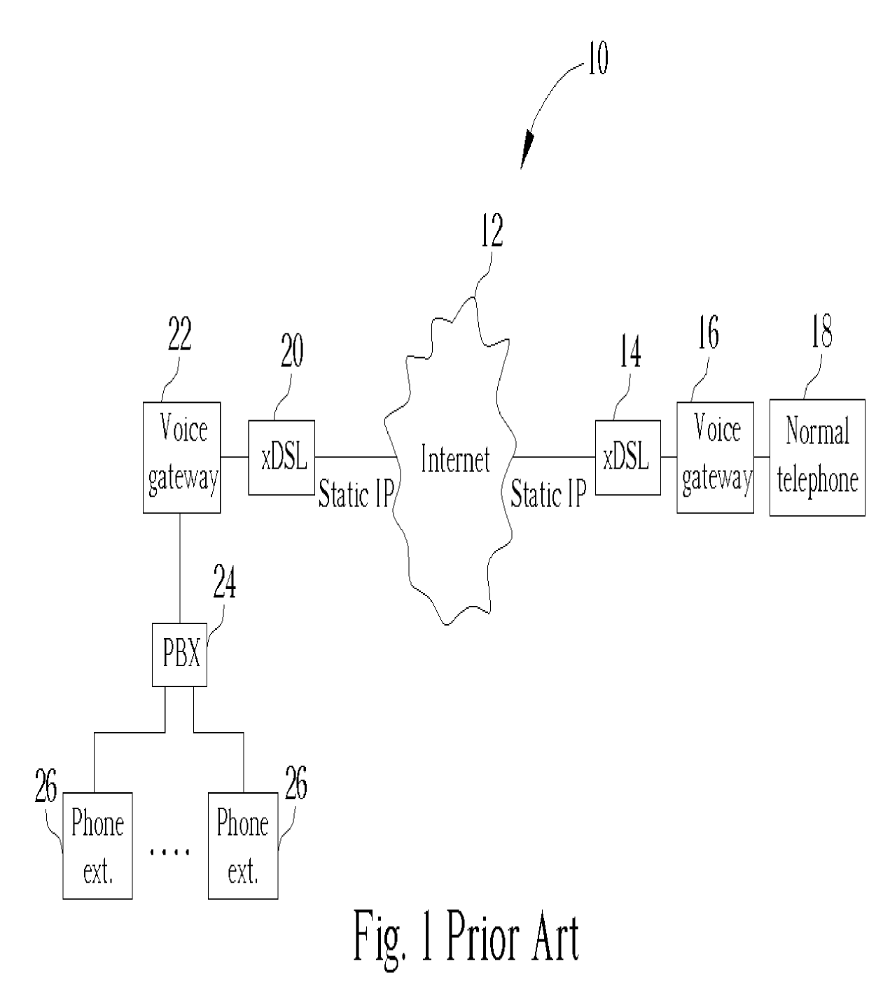

FIG. 2 is a diagram of a roaming communication system according to a first embodiment of the present invention.

FIG. 3 is a diagram of a roaming communication system according to a second embodiment of the present invention.

### DETAILED DESCRIPTION

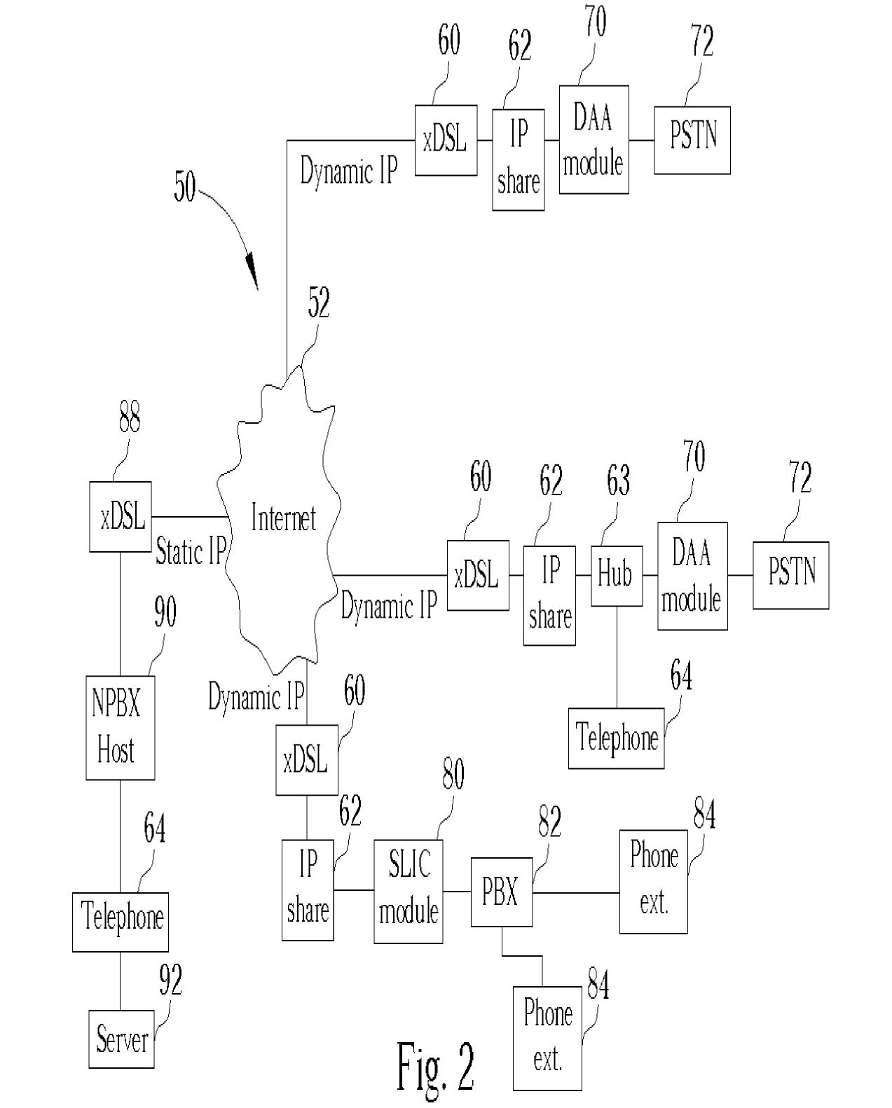

Please refer to FIG. 2. FIG. 2 is a diagram of a roaming communication system 50 according to a first embodiment of the present invention. The roaming communication system 50 allows any type of telephone to make a phone call over the Internet 52, so long as the telephone is connected to the roaming communication system 50 in one of several ways. As shown in the top right portion of FIG. 2, a public switched telephone network (PSTN) 72 is connected to the roaming communication system 50 through a data access arrangement (DAA) module 70. The DAA module 70 contains one or more telephone line connectors (such as RJ11 connectors) for connecting the DAA module 70 to one or more telephone lines of the PSTN 72. In addition, the DAA module 70 also contains a network cable connector (such as an RJ45 connector) for connecting the DAA module 70 to an IP sharing device 62. The IP sharing device 62 contains a hub or switch, and is used to share an Internet connection 60 with each network device connected to the IP sharing device 62. Unlike the VoIP system 10 of the prior art, the roaming communication system 50 only needs a dynamic IP address to be provided by the Internet connection 60, and does not require a stable static IP address for connecting additional telephones or telephone networks to the roaming communication system 50.

As shown in the middle right portion of FIG. 2, another public switched telephone network (PSTN) 72 is connected to the roaming communication system 50 through another data access arrangement (DAA) module 70. The only difference is a hub 63 is connected to the IP sharing device 62 to share the Internet connection 60 to a telephone 64 in addition to the DAA module 70. The telephone 64 has a network connector such as an RJ12 connector for connecting the telephone 64 to the hub 63. Therefore, the telephone 64 can utilize the roaming communication system 50 through any shared or unshared connection to the Internet 52 using a dynamic IP address. Similarly, the PSTN 72 can also connect to the roaming communication system 50 via the DAA module 70. The DAA module 70 and the telephone 64 both contain circuitry that converts voice signals into voice packets for transmitting the voice packets via the Internet 52. Likewise, the circuitry also converts voice packets received through the Internet 52 into voice signals that are then sent to the respective telephone 64 or telephone line in the PSTN 72.

Besides connecting the PSTN 72 to the roaming communication system 50, a private branch exchange (PBX) 82 can also be used. As shown in the bottom portion of FIG. 2, the PBX 82 is connected to the roaming communication system 50 through a SLIC module 80. Like the DAA module 70, the SLIC module 80 contains a network cable connector (such as an RJ45 connector) for connecting the SLIC module 80 to the IP sharing device 62. The PBX 82 is connected to a plurality of phone extensions 84 for allowing the phone extensions 84 to utilize the roaming communication system 50 through the PBX 82 and the SLIC module 80.

The DAA modules 70 and the SLIC module 80 are all connected to the Internet 52 through Internet connections 60 that provide dynamic IP addresses. The entire roaming communication system 50 can be controlled by a network private branch exchange (PBX) host 90. The network PBX host 90 is connected to the Internet 52 through another Internet connection 88, which provides a static IP address. Another telephone 64 is connected to the network PBX host 90, and a server 92 is connected directly to the telephone 64. The network PBX host 90 provides telephone service to each of the telephones 64, to phones in the PSTNs 72, and to the phone extensions 84 in the PBX 82 that utilize the roaming communication system 50 to make telephone calls. The server 92 is used to coordinate all data transmitted and received in the roaming communication system 50.

The roaming communication system 50 is said to be roaming because each of the telephones 64, the phones in the PSTN 72, and the phone extensions 84 in the PBX 82 can be connected to the Internet 52 anywhere that a dynamic IP address is present. A static IP address can also be used, but is not necessary when using the present invention.

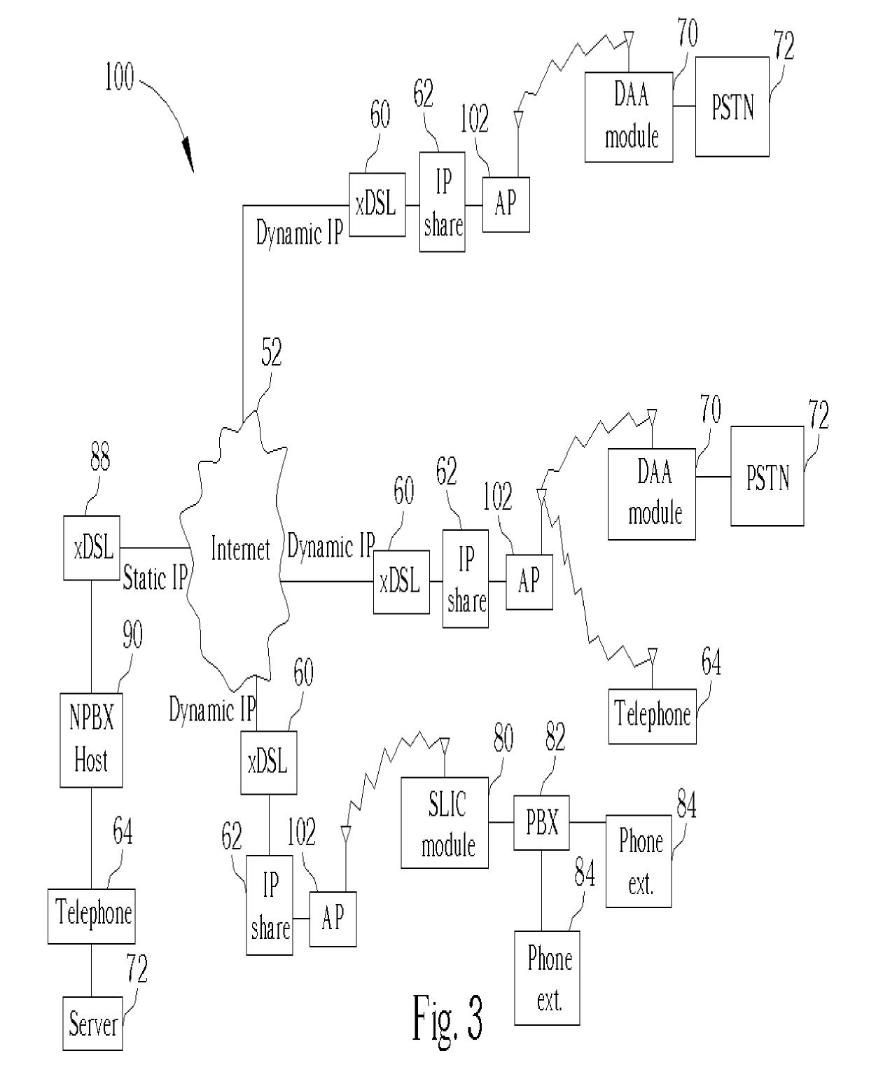

In FIG. 2, all devices are connected to the roaming communication system 50 through wired connections using the IEEE 802.3 protocol. Please refer to FIG. 3. FIG. 3 is a diagram of a roaming communication system 100 according to a second embodiment of the present invention. The roaming communication system 100 is similar to the roaming communication system 50 shown in FIG. 2, and the same reference numbers will be used to refer to the same parts. Instead of using wired connections to connect the DAA modules 70, the telephone 64, and the SLIC module 80, the roaming communication system 100 utilizes access points 102 to wirelessly connect with the devices in the roaming communication system 100. As shown, the DAA modules 70, the telephone 64, and the SLIC module 80 can all communicate with the access points 102 using at least one of the many IEEE 802.11x protocols.

In contrast to the prior art, the present invention roaming communication system utilizes dynamic IP addresses to connect all network devices to the roaming communication system. Only the host device requires a static IP address so that the other network devices have a stable address in which to communicate with the host. Thus, telephones, PSTNs, and PBXs can be added to the roaming communication system at any time, and without additional cost involved to register a static IP address. Moreover, the roaming communication system only requires a single host, and does not require a server or voice gateway at each geographical location of the roaming communication system.

Those skilled in the art will readily observe that numerous modifications and alterations of the device may be made while retaining the teachings of the invention. Accordingly, the above disclosure should be construed as limited only by the metes and bounds of the appended claims.

1. A roaming communication system, comprising:
a first local telephone system;
a first communication module connected to the first local telephone system and connected to the Internet through a first dynamic IP address, the first communication module capable of converting voice signals received from the first local telephone system to voice packets for transmission over the Internet and capable of restoring voice packets received through the Internet into voice signals;
a second local telephone system;
a second communication module connected to the second local telephone system and connected to the Internet through a second dynamic IP address, the second communication module capable of converting voice signals received from the second local telephone system to voice packets for transmission over the Internet and capable of restoring voice packets received through the Internet into voice signals; and
a host connected to the Internet through a static IP address, the host capable of controlling voice packet traffic between the first communication module and the second communication module.

2. The roaming communication system of claim 1 wherein the first communication module is a data access arrangement (DAA) module, the first local telephone system is a public switched telephone network (PSTN), and the DAA module is connected to the PSTN through at least one phone line.

3. The roaming communication system of claim 1 wherein the second communication module is a subscriber line interface circuit (SLIC) module and the second local telephone system is a private branch exchange (PBX).

4. The roaming communication system of claim 1 wherein the first and second communication modules are each connected to the Internet through a network cable according to the IEEE 802.3 protocol.

5. The roaming communication system of claim 1 wherein the first and second communication modules are each wirelessly connected to the Internet through an access point, and the first and second communication modules wirelessly communicate with the respective access points according to an IEEE 802.11x protocol.

6. The roaming communication system of claim 1 wherein the host comprises a network private branch exchange (PBX) for managing telephone connections within the roaming communication system.

7. The roaming communication system of claim 6 wherein the host comprises a server connected to the network PBX for controlling data traffic in the roaming communication system.
